(19) United States
(12) Patent Application Publication
(10) Pub. No.: US 2020/0359809 A1
(43) Pub. Date: Nov. 19, 2020

(54) DISPENSING SYSTEM FOR DISPENSING CUTLERY AND UTENSILS

(71) Applicant: World Centric Corp., Petaluma, CA (US)

(72) Inventors: Ian Coats MacColl, Mill Valley, CA (US); Nicholas Riddle, Tiburon, CA (US)

(73) Assignee: World Centric Corp., Petaluma, CA (US)

(21) Appl. No.: 16/411,116

(22) Filed: May 13, 2019

(51) Int. Cl. A47F 1/10; B65G 1/04; B65G 1/08; B65G 1/14; B65G 11/02; B65G 11/20; A47F 10/06

(52) U.S. Cl. CPC A47F 1/10; B65G 1/0471; B65G 1/08; B65G 1/14; A47F 2001/103; B65G 11/203; A47F 10/06; B65G 2207/26; B65G 11/023

(57) ABSTRACT

In a dispensing system for utensils and cutlery, a housing with a cutlery distribution area has one or more openings for exposing a handle end of a presenting utensil for removal by a user. The system has one or more stack chambers, each configured to hold a vertical stack of utensils. A trigger assembly within the housing is actuated by the user removing a single presenting utensil out of an opening, causing the release of a single lowest utensil from the vertical stack, for presentation as the next presenting utensil for removal by a next user. A chute delivers each released single lowest utensil of a vertical stack to its opening for removal by the next user, and causes the released utensil to rotate about its axis from entry into the chute to exit at the opening.

### BACKGROUND

### Field.

The example embodiments in general are directed to a cutlery dispensing system for dispensing cutlery and utensils hygienically without users having to physically touch any part of a dispenser, other than the specific utensil they wish to dispense for their use.

### Related Art.

Disposable cutlery or utensils such as plastic or bio-degradable spoons, forks, knives, and SPORKS® are normally used in casual restaurant settings and are provided by the eating establishment for use in the restaurant and with take-out food. The disposable cutlery may represent a less expensive alternative to reusable cutlery, for example, at eating facilities or social gatherings where it is undesirable or cost prohibitive to clean the cutlery for reuse. However, providing disposable cutlery may present a number of potential drawbacks related to the manner in which the cutlery is provided.

Certain eating facilities may provide disposable cutlery in loose form within open-air bins or similar containers in which all patrons place their hands to grasp and retrieve a fork, spoon, knife, or spork. Open-air bins are relatively unhygienic, however, and may facilitate transmission of bacteria and the like from one patron to the cutlery and ultimately to another patron.

To ensure that this cutlery is provided in a hygienic form, a purveyor often purchases bulk quantities of individual portions of cutlery each pre-sealed in a small bag. The bag may also contain a napkin, dry condiments, and a hand sanitizer wipe. Such bags are generally more expensive than the sum of individual utensils due to the processing and materials necessary to form the bags. Also, these bags may provide more items than the user requires, which is uneconomical.

An option to such prepackaged bags is the presentation of cutlery in a tray or cup positioned near the point of sale. This approach allows the customer to select only the utensils desired. However, this form of supply can be unsanitary and unhygienic if a customer does not take a utensil that is purposely touched or inadvertently brushed against while rummaging through the proffered selection to find the perfect spoon for soup, for example. Airborne pathogens may settle on exposed surfaces of the remaining cutlery. The unregulated dispensing of the cutlery also permits the customer to take more utensils than needed, thus resulting in a lower profit margin for the establishment.

Accordingly, in addition to the issues noted above, other factors such as reduced antibiotic effectiveness coupled with an increasingly fast food directed environment, have combined to create a need for a new cutlery dispenser. The dispenser should have both the ability to dispense cutlery in a hygienic manner and also provide an inventory control means in that it allots only one utensil per actuation.

A conventional sanitary cutlery dispenser is disclosed in U.S. Pat. No. 8,272,533, currently assigned to Waddington N. America of Massachusetts. The '533 patent describes an apparatus and a method of dispensing. FIG. 1 is a side view of a utensil dispenser in the '533 patent; FIG. 2 an expanded section view of the dispenser escapement mechanism of the dispenser of FIG. 1, and FIG. 3 a detail section dispensing view of the utensil dispenser. Referring to FIGS. 1-3, the dispenser 100 and method each require some type of “spring” leaf escapement mechanism 15 (met for example by an escapement leaf spring 30 with an escapement actuator finger 26).

The escapement leaf spring 30 is mounted to an escapement spring axle 32 to allow the movement of escapement leaf spring 30 during the movement of the escapement actuator finger 26 from a rest position 25 (FIG. 2) to an extended position 25′ (FIG. 3). The escapement actuator finger 26 is held in place by an escapement actuator axle 36 that allows the pivoting motion between the rest position 25 and the extended position 25′. This motion, combined with an escapement actuator 38 being sandwiched between the two tines 16 and 34 of the escapement leaf spring 30, creates an expansion of the two spring tines 16 and 34, permitting the singular dispensing of a utensil 10 while retaining the next to last utensil 10′.

Thus, the escapement mechanism 15 has two pivot points. The first pivot point is connected to the housing front wall and escapement mechanism 15. This is shown by the escapement spring axle 32 being connected to the escapement leaf spring 30, permitting the leaf spring 30 to move (together with an actuator 38 to expand spring tines 16, 34) based on pivoting movement of the leaf escapement finger 26). There is a second pivot point (at axle 36) that allows pivoting motion of finger 26 once a utensil 10 that is being removed contacts the finger 26.

Accordingly, removal of a utensil 10 from escapement mechanism 15 in the '533 patent causes contact with a bottom end of the finger 26, deflecting its bottom end laterally outward, forcing it to pivot inward via axle 36 (at its top) and also to cause movement of the leaf spring 30 and actuator 38 via its pivot axle 32. The actuator 38 then spreads the spring tines 16, 34 (expands), to permit a utensil 10 to drop and a next to last utensil 10′ and its stack to be held by the protrusion on spring tine 34 (upper tine).

Therefore, in the '533 patent there is a key functional requirement that the escapement actuator finger 26 undergoes multiple pivot rotations against spring pressure to cause a utensil 10 to drop. There is a need for a better solution to sanitary cutlery dispensing that what is shown and described in the '533 patent and elsewhere in the prior art. Namely, there is an industry need for an improved cutlery dispenser system that conforms to the highest standards of hygienic practices, while providing a secure dispensing system with an improved process of dispensing cutlery and utensils in a controlled fashion.

### SUMMARY

An example embodiment of the present invention is directed to a dispensing system for utensils and cutlery. The system includes a housing having a cutlery distribution area with at least one opening therein for exposing a handle end of a presenting utensil for removal by a user. The system additionally includes a stack assembly having at least one stack chamber configured to hold a vertical stack of utensils and aligned with the at least one opening. The system further includes a trigger assembly actuated by the user removing a single presenting utensil out of the at least one opening to release a single lowest utensil from the vertical stack, for presentation of its handle end extending out of the at least one opening at the cutlery presentation area for removal by a next user. A chute delivers each released single lowest utensil of the vertical stack to its at least one opening for removal by the next user.

Another example embodiment is directed to a utensil dispensing system. The system includes a housing, a lower part of which includes a plurality of spaced adjacent openings therein, each opening exposing a handle end of a presenting utensil for removal by a user. The system additionally includes a plurality of stack chambers in adjacent relation to one another, each configured to hold a vertical stack of utensils and aligned with a corresponding opening, and a trigger assembly actuated by the user removing a single presenting utensil out of one of the openings by its handle end to release a single lowest utensil from the vertical stack within the stack chamber associated with that opening, as a next presenting utensil for removal by a next user of the system. The system further includes a chute for delivering each released single lowest utensil to its corresponding opening for removal by the next user, the released single lowest utensil subject to rotation as it is released into the chute.

Another example embodiment is directed to a utensil dispensing system. The system includes a housing, a lower part of which includes a plurality of spaced adjacent openings therein, each opening exposing a handle end of a presenting utensil for removal by a user. The system additionally includes a plurality of stack chambers in adjacent relation to one another, each configured to hold a vertical stack of utensils and aligned with a corresponding opening, the top of each stack chamber and an interior passage extending downward within each chamber having a unique shape that respectively mimics the profile of one or more of a fork, spoon, spork, and knife. The system further includes a trigger assembly actuated by the user removing a single presenting utensil out of one of the openings by its handle end to release a single lowest utensil from the vertical stack within the stack chamber associated with that opening, as a next presenting utensil for removal by a next user of the system.

### BRIEF DESCRIPTION OF THE DRAWINGS

Example embodiments will become more fully understood from the detailed description given herein below and the accompanying drawings, wherein like elements are represented by like reference numerals, which are given by way of illustration only and thus are not limitative of the example embodiments herein.

FIG. 1 is a side view of a prior art utensil dispenser.

FIG. 2 is an expanded sectional view of the dispenser escapement mechanism of the prior art dispenser shown in FIG. 1.

FIG. 3 is a detail sectional dispensing view of the prior art utensil dispenser of FIG. 1.

FIG. 4 is a perspective view of a dispensing system for cutlery and utensils according to an example embodiment.

FIG. 5 is a right-side elevational view of a refill cartridge according to the example embodiments.

FIG. 6 is a top perspective view of the refill cartridge shown in FIG. 5.

FIG. 7 is a perspective view of the dispensing system with the housing removed to show internal elements therein in more detail.

FIG. 8 is a rear perspective view of FIG. 7.

FIG. 9 is an exploded parts view of the example dispensing system for cutlery and utensils.

FIG. 10 is a partial sectional view with selected structural components removed to show selected internal components of the system in more detail.

FIG. 11 is a partial sectional view with selected structural components removed to show selected internal components of the system in more detail.

FIG. 12 is a partial sectional view with selected structural components removed to show selected internal components of the system in more detail.

FIG. 13 is a partial sectional view with selected structural components removed to show selected internal components of the system in more detail.

FIG. 14 is an enlarged, partial sectional view with selected structural components removed to show selected internal components of the system in more detail.

FIG. 15 is an enlarged, partial sectional view with selected structural components removed to show selected internal components of the system in more detail.

FIG. 16 is an enlarged, partial sectional view with selected structural components removed to show selected internal components of the system in more detail.

FIG. 17 is an enlarged view of a chute and its relationship to the ejection tab and the fixed ledge, according to the example embodiments.

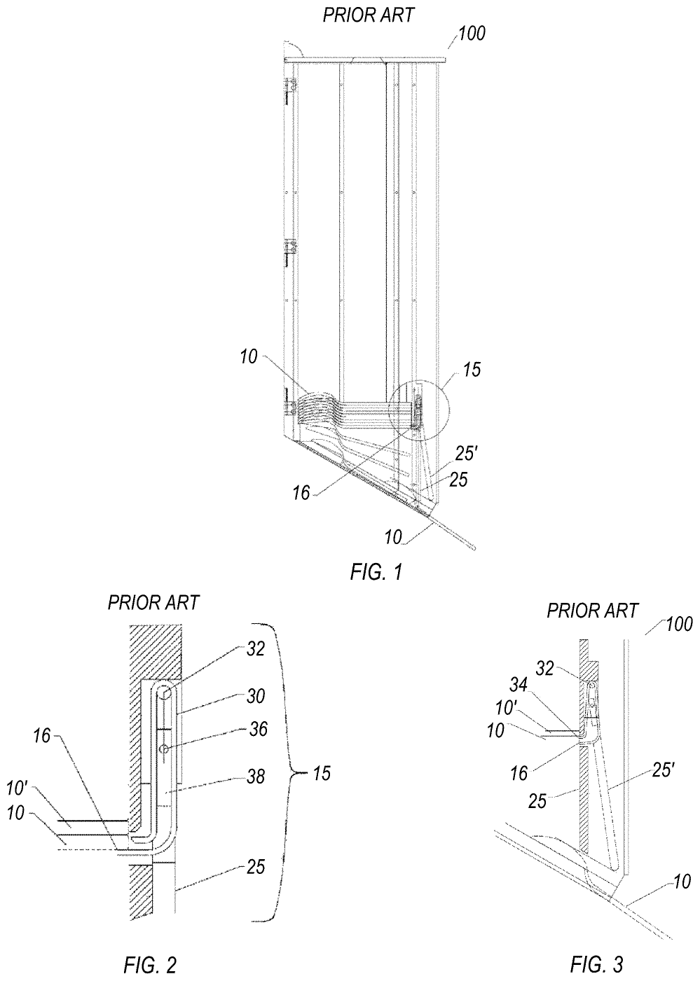

### DETAILED DESCRIPTION

In the following description, certain specific details are set forth in order to provide a thorough understanding of various example embodiments of the disclosure. However, one skilled in the art will understand that the disclosure may be practiced without these specific details. In other instances, well-known structures associated with manufacturing techniques have not been described in detail to avoid unnecessarily obscuring the descriptions of the example embodiments of the present disclosure.

Unless the context requires otherwise, throughout the specification and claims that follow, the word “comprise” and variations thereof, such as “comprises” and “comprising,” are to be construed in an open, inclusive sense, that is, as “including, but not limited to.”

Reference throughout this specification to “one example embodiment” or “an embodiment” means that a particular feature, structure or characteristic described in connection with the embodiment is included in at least one embodiment. Thus, the appearances of the phrases “in one example embodiment” or “in an embodiment” in various places throughout this specification are not necessarily all referring to the same embodiment. Further, the particular features, structures or characteristics may be combined in any suitable manner in one or more example embodiments.

As used in this specification and the appended claims, the singular forms “a,” “an,” and “the” include plural referents unless the content clearly dictates otherwise. The term “or” is generally employed in its sense including “and/or” unless the content clearly dictates otherwise.

As used in the specification and appended claims, the terms “correspond,” “corresponds,” and “corresponding” are intended to describe a ratio of or a similarity between referenced objects. The use of “correspond” or one of its forms should not be construed to mean the exact shape or size. In the drawings, identical reference numbers identify similar elements or acts. The size and relative positions of elements in the drawings are not necessarily drawn to scale.

The example embodiments hereafter describe a dispensing system for dispensing cutlery and utensils hygienically without users having to physically touch any part of a dispenser, other than the specific utensil they wish to dispense for their use. As will be shown in more detail below, in the system a utensil handle is presented at a cutlery distribution area outside the housing for access by a user when the user approaches the system. Multiple stacks of utensils are provided in adjacent relation within designated stack chambers arranged inside a housing of the system.

The example system offers a much more sanitary dispensing process that does not require the user to touch a button or anything else to release the utensil. As a user pulls a handle and hence utensil out from the cutlery distribution area, that action triggers the next utensil directly above it to drop from the designated stack chamber and present in a similar way for the next user. Accordingly, the example system can generally be loaded with multiple stacks of utensils, and during loading, the operator does can load the utensil stacks without having to physically touch any utensil, maintaining the sanitary integrity of the cutlery in place. If the system becomes jammed, however, it may become necessary to touch one or more utensils or pieces, but these can be removed from the system by taking out one at a time in the ordinary fashion.

Particularly, the example system offers presentation of an end of a utensil, wherein the system employs two counter-sliding blades which allow a single utensil to drop, while constraining the utensil stack within a given stack chamber. Accordingly, the dispenser system requires no touch to distribute a new utensil except by pulling the previous utensil out of the housing by its handle. One benefit is improved sanitary conditions to prevent the spread of germs. The example system also provides significant customer convenience and promotes refilling of designated cutlery and utensil product designed for use in the system.

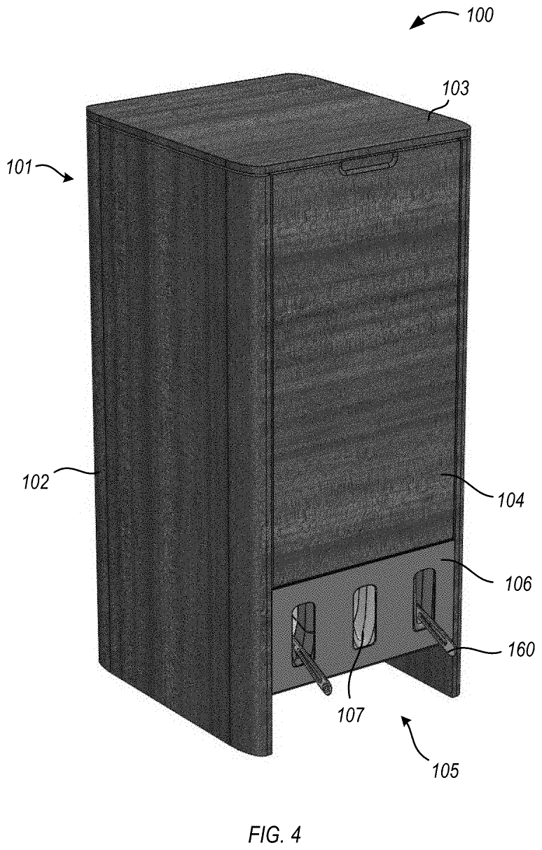

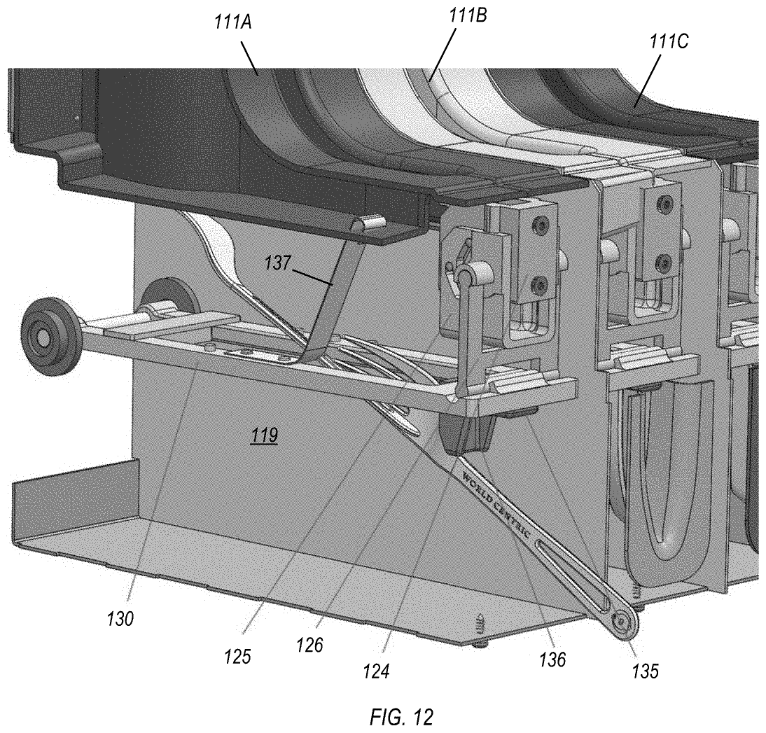

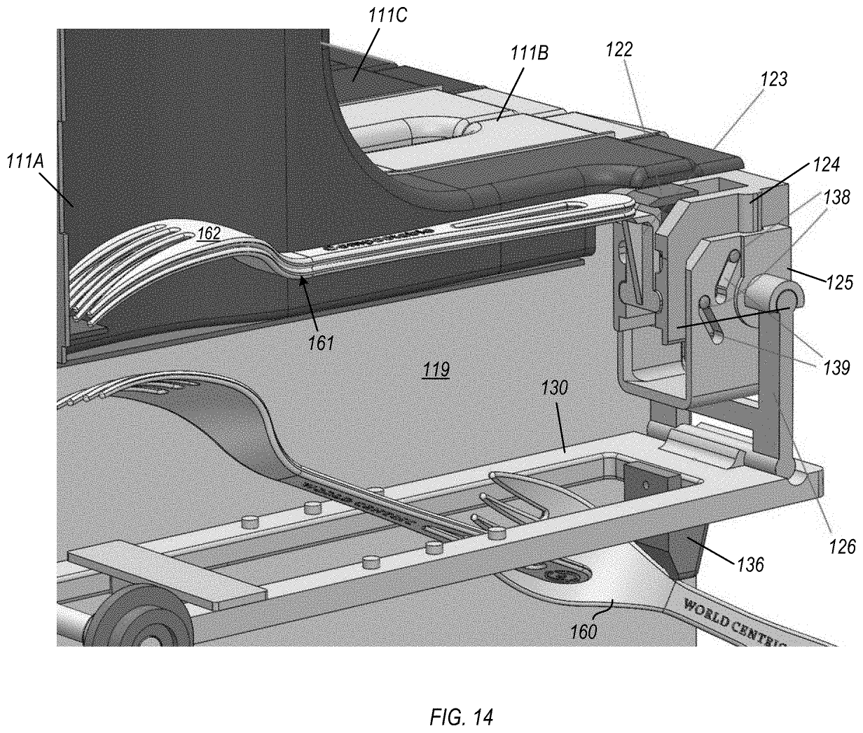

Referring now to FIGS. 4-17, system 100 includes a housing 101 with side access panels 102, a top access panel 103, and a front access panel 104. In an example, the panels of housing 101 may be made of a wood product, although such could be replaced by any of a synthetic (plastic/rubber), composite wood/plastic, and like materials. System 100 further includes a cutlery distribution area 105 which includes a sheet metal facing panel 106 with at least one opening 107 that presents the handle of a lowest utensil 160 in a given refill cartridge of utensils contained within housing 101. For example purposes only, the example embodiments illustrate a series of spaced-adjacent openings 107 that present the handle end to the user. System 100 includes a stack assembly 110 having at least one stack chamber which is configured to hold a vertical stack of utensils in a horizontal, face down orientation with the handle end presented outward from the housing 101. For example purposes only, stack assembly 110 may include multiple stack chambers, which as shown from left to right in adjacent relation, include a fork stack chamber 111A, a spoon stack chamber 111B, and a knife stack chamber 111C, it being understood that additional stack chambers could be provided or the different utensils arranged in another order (all sporks, or also different configurations like all forks if a customer so desired). Each stack chamber 111A can be formed of two halves or as one integrally molded part with cutouts.

The stack assembly 110 includes outer side metal sheets 114, a front lower plate 115, and a rear metal plate 117 with support brace 118 that bound the stack chambers 111A-C. Plates 114, 115 and 117 are secured to inner surfaces of the various access panels 102, 104 via suitable fasteners, which in one example may include wood screws with lock washers 116A, as well as sheet metal screws 116B. The outer side metal sheets 114 could also be included into the structure of the stack assembly 110 inside of attached thereto.

The internal components within the housing 101 of system may be understood as comprising three primary part groups or assemblies: (a) the stack assembly 110, which includes one or more of the aforementioned chambers 111A-C, each of which may be configured to hold a given number of utensils 160 or pieces of cutlery, one example being a vertical stack of 50 in each chamber 111A-C for a total of 150 pieces; (b) a trigger assembly that is actuated by the user removing a single presenting utensil 160 from one or more openings 107 in the cutlery presentation area 105 to release a single utensil 160 piece at a time per opening 107, resetting the previously-removed utensil 160 with another lowest sitting utensil 160 of the vertical stack of utensils in a given chamber 111A-C in a ready position; and (c) a chute 140 for delivering each lowest sitting ready utensil 160 or piece of cutlery to the opening 107 for removal by a next user. In an example detailed further below, the chute 140 by its construction causes a dropping utensil to rotate 90 degrees from the position in which it was released from its lowest location in the vertical stack in the stack chamber, to where its handle exits opening 107 for presentation to the user.

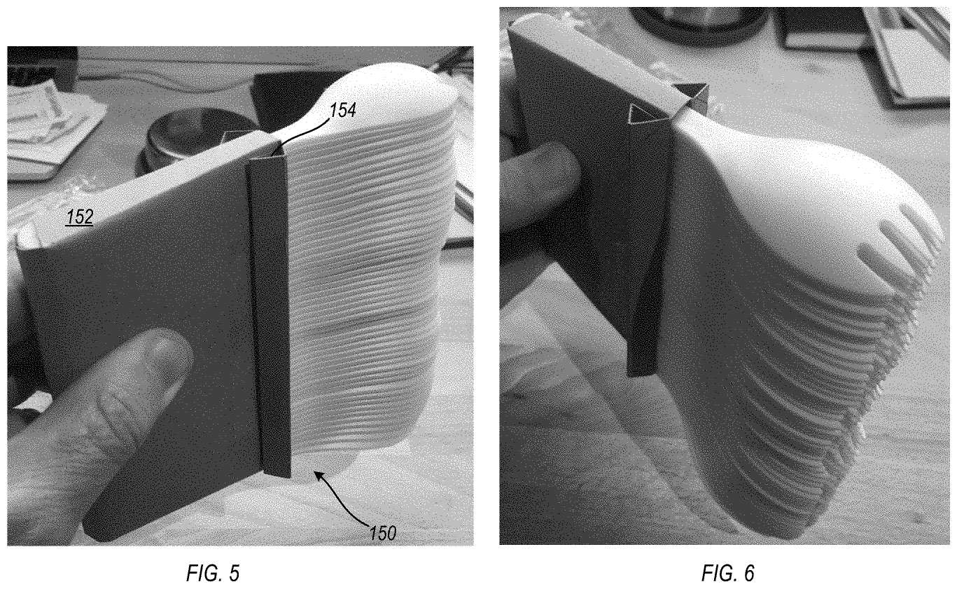

In a loading operation, a person removes the front access panel 104 and then flips up the top access panel 103 (top access panel 103 is hinged at back to provide access from above). This gives access for the user to take a packaged load of 50 vertically-stacked utensils 160 (“refill cartridge 150”) and to feed it into its respective stack chamber 111A-C of the stack assembly 110 from the top. Referring to FIGS. 5 and 6, the refill cartridge may include a bound stack of utensils 160 secured within a sanitary or binding wrapper 152 (in the example the binding wrapper 152 is made of paper. The wrapper 152 and its oppositely formed flanges 154 help facilitate loading the new stack of utensils 160 without violating sanitary integrity, so as to secure the refill stack down within a given stack chamber 111A-C. Alternatively, the binding wrapper 152 may be composed of a material selected from any of fiber sandwich, adhesive tape, shrink-wrap material, etc.

For a reload operation, the user grasps wrapper 152 and lowers the refill cartridge 150 as far down into a chamber 111A-C as possible and then removes the binding wrapper 152 which holds the utensils 160 together in the refill cartridge 150. In general, the binding wrapper may include a pull tab or perforations along the wrapper 152 and/or flanges 154 that facilitate removal. Additionally, a front scooped-out portion or channel 112 is provided down the length of each stack chamber 111A-C. This provides hand access of an operator's hands for more easily clearing jams in the vertical columns of utensils 160.

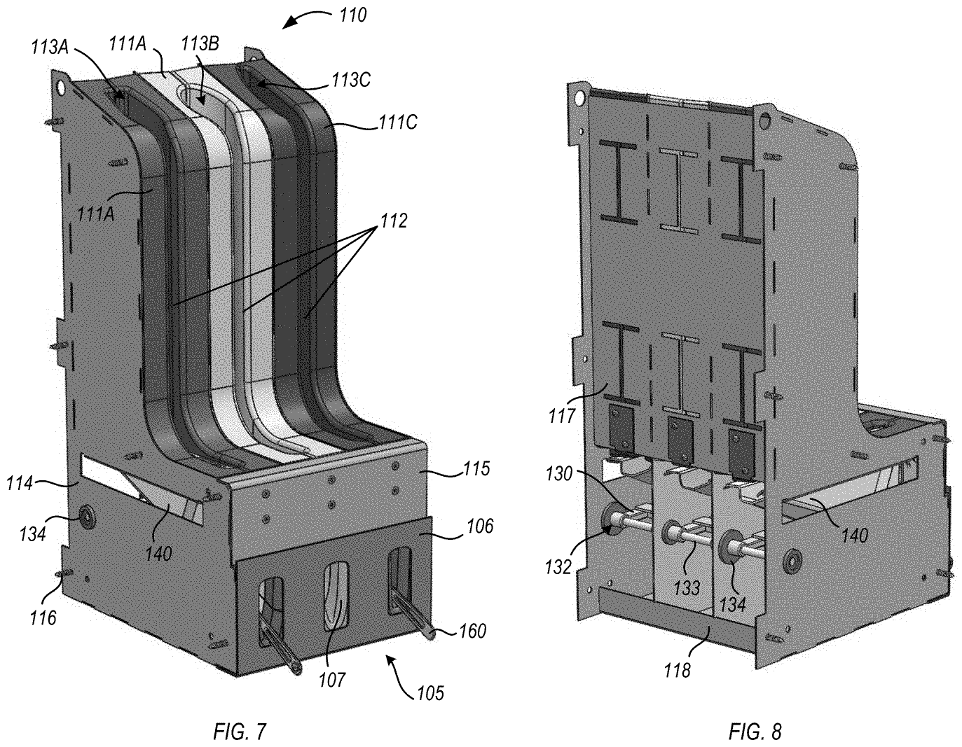

The top of each stack chamber 111A-C and the interior down within each chamber 111A-C has a unique shape (see openings 113A-113C) that mimic the profile of any of a fork, spoon, spork, and/or knife, as best seen in FIG. 7. Because of the unique geometry of each chamber 111A-C, the distinct profile of each utensil 160 inhibits the inserting of incorrect shaped utensils and also prevents a given utensil 160 from being pulled out forward towards the user while in a given stack chamber 11A-C. In this way, the stack chambers 11A-C of the stack assembly 110 are designed to hold the new cutlery in place while the paper binding wrapper 152 of the refill cartridge 150 of utensils 160 is removed.

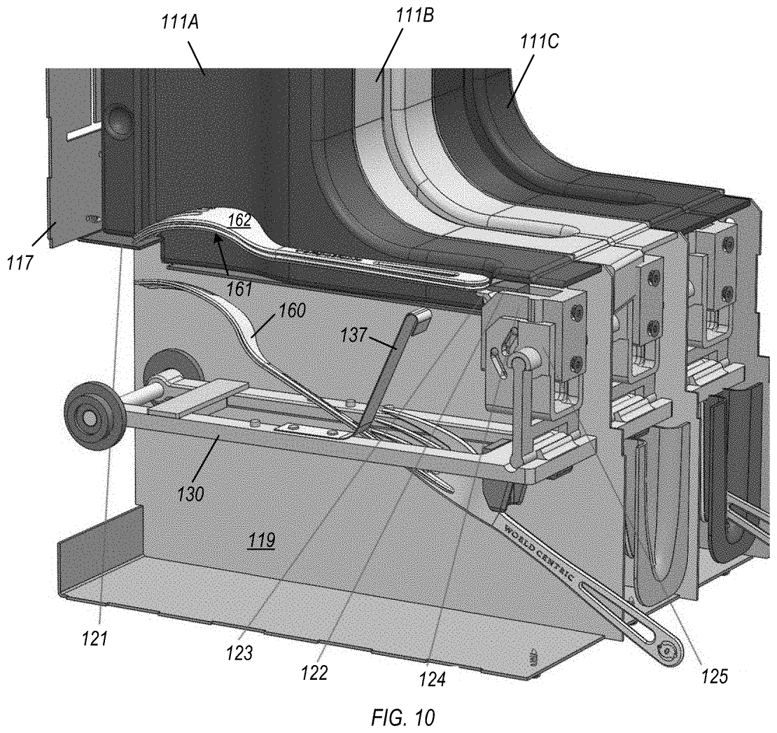

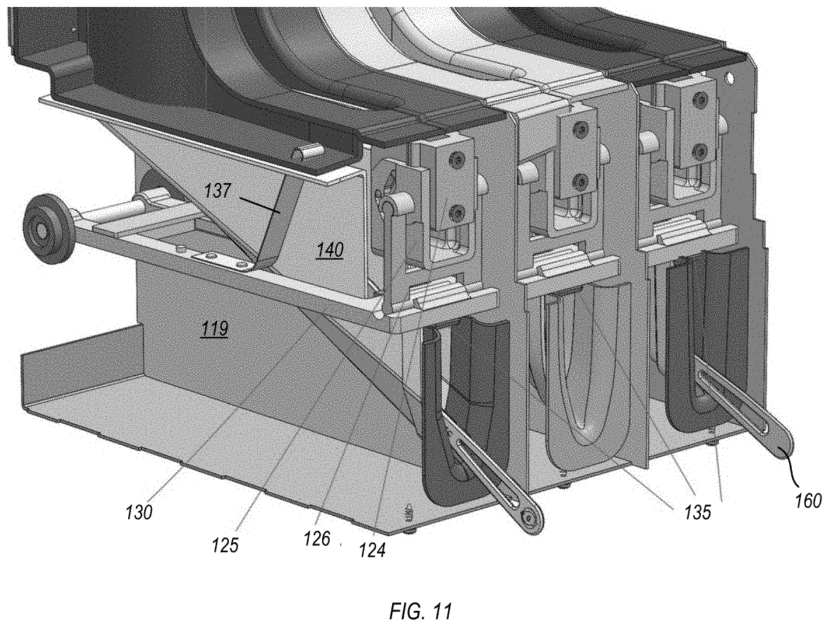

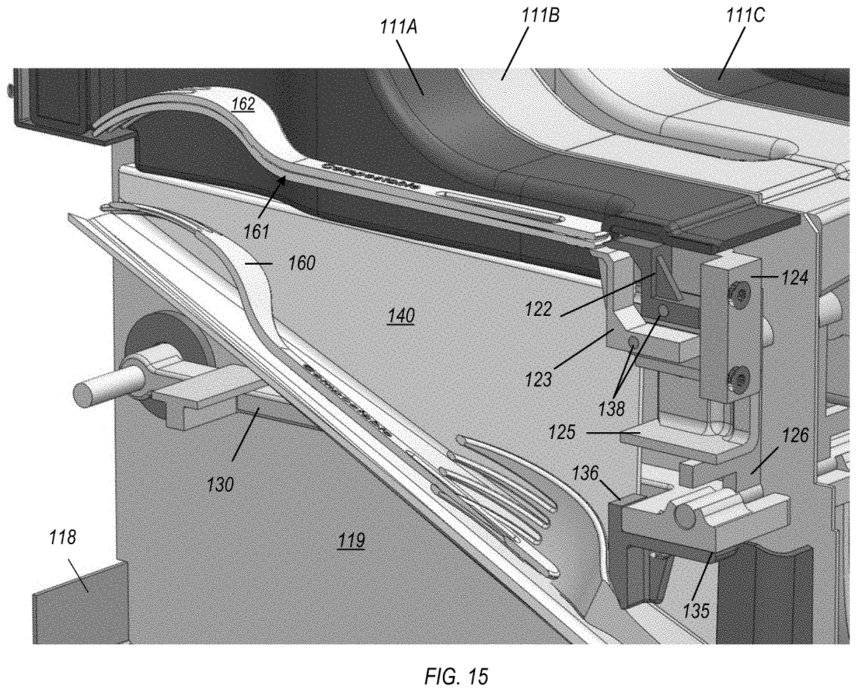

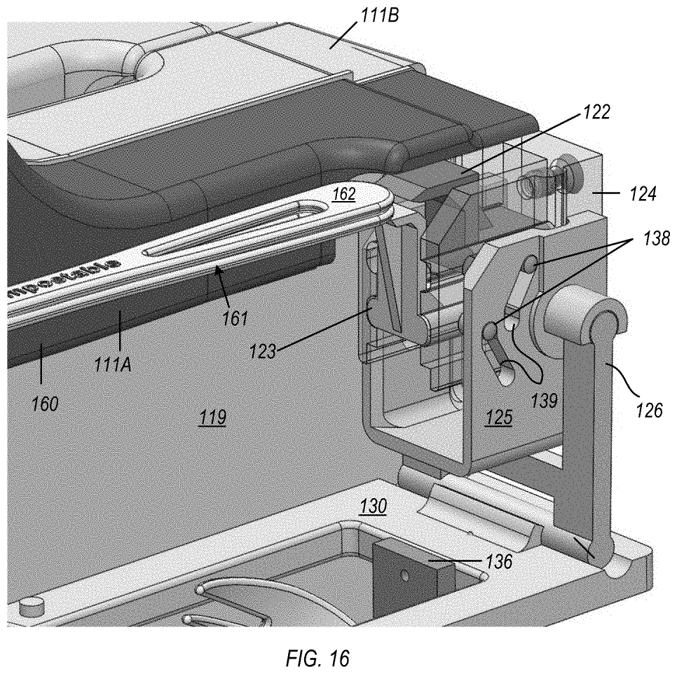

With reference now to FIGS. 10 through 16, the trigger assembly includes a fixed shelf 121 located at an interior rear area within housing 101 (rear of system 100), facing and engaging an eating end of a given utensil (in the face down position) within the chambers 111A-C, and a movable shelf opposite the fixed shelf 121 and located at an interior forward area within a given stack chamber 111A-B at its lower end, facing the handle end of the utensil 160 (front of the system 100). The movable shelf comprises a pair of chisels 122, 123 supported in a chisel carrier 124, which in turn is supported on a cam body 125 connected to a pushrod 126 that in turn engages a widthwise crescent-shaped recess in an actuator arm 130. The chisels include an upper chisel 122 and a lower chisel 123, each of which are arranged so as to come into contact with the handle end of a utensil 160. The upper chisel 122 and lower chisel 123 move counter-cyclically via specially designed defined paths 139 that are formed in the sides of the cam body 125 (diagonal and straight slots) with axles 138 extending through each respective chisel 122, 123, each axle 138 (with its attached chisel 122/123) moving along its respective defined path 139 depending on whether a handle end of a presenting utensil 160 is being removed by a user from the opening 107 at the cutlery presentation area 105. As best seen in FIGS. 15 and 16, in a starting position the lower chisel 123 is deployed to act as a shelf to support the handle end of the utensil 160.

With continued reference to FIGS. 15 and 16, there is a “next-in-line” lowest utensil of the vertical utensil column in the stack chamber 111A-C in the ready position (hereafter “ready utensil 161”) face down and ready to drop, and there is a further next-lowest utensil (hereafter the “on-deck” utensil 162) directly above the ready utensil 161 at the bottom of a given stack chamber 111A-C. Upon actuation via a user pulling out a presenting utensil 160 by its exposed handle end extending out of an opening 107 (to be discussed in more detail hereafter) the upper chisel 122 moves laterally inward toward the handle end to act as a shelf for the on-deck utensil 162 directly above the ready utensil 161.

Once the upper chisel 122 is in place to act as a shelf for the on-deck utensil 162, the lower chisel 123 retracts laterally away from the handle end to allow the ready utensil 161 to drop into the chute 140 (also there is an additional ledge (not shown) within chute 140 that acts as a trigger for rotating the ready utensil 161 (as it is released from its vertical stack of utensils) by 90 degrees as it travels through the chute 140), so as to become the next presenting utensil 160 with its handle end exposed through opening 107 for removal by a next user, with the on-deck utensil 162 now becoming the ready utensil 161, etc. The handle end of the ready utensil 161 drops first, because of the fixed shelf 121 supporting the other end (eating end) of the ready utensil 161.

Referring to FIGS. 10 through 13, the trigger assembly further includes a spring 137 and the actuator arm 130, with the spring 137 connected at on end to the actuator arm 130 and at the other end to a surface of a given stack chamber (fork stack chamber 111A shown by example). A distal end of the actuator arm 130 closest to the front of the housing 101 is connected to the lower end of the pushrod 126. The distal end of actuator arm 130 also supports a button 135 and a barrier element 136 thereon, the functions of which are to be discussed in more detail hereafter. In a variant, both the button 135 and barrier element 136 can be integrally formed as part of the actuator arm 130.

A proximal end of the actuator arm 130 nearest the rear metal plate 117 includes a lever brace 131 for support and is connected between an interior separator plate 119 (which separates stack chamber 111A from 111B and stack chamber 111B from 111C) and the outer side metal sheet 114 via an axel rod 133 which extends through all central openings of fixed axle bushings 134, pairs of each bounding the actuator arm 130 proximal end there between, each axle bushing 134 securable in one of sheets 114 and 119. A junction where each edge of the proximal end of actuator arm 130 meets a portion of axle rod 133 and meets an axle bushing 134 forms a pivot moment 132. The actuator arm 130 is able to pivot at pivot moment 132 about the axle rod 133 as the axles 138 shift in the defined areas 139 formed in the cam body 125, which occurs upon a user actuating force imparted by the user pulling a presenting utensil 160 out of opening 107 in the facing plate 106 at the cutlery presentation area 105.

Upon release, spring force from spring 137 causes the elements of the trigger assembly to return to the starting position, while reloading a new handle end of a presenting utensil 160 in each opening 107 via chute 140. The spring 137 is connected between a given stack chamber 111A-C and a surface of the actuator arm 130. The upper end of the spring 137 pushes along the bottom surface of the stack chamber 111A. In particular, and as best shown in FIGS. 10 and 11, spring 137 is shown in the manufactured position, not in its assembled position. Spring 137 has a lower planar or flat end attached to a planar surface of the actuator arm 130, and an elongate portion which extends upward from the flat end at a diagonal to terminate biased against so as to slide along an underside of stack chamber 111A.

Because the trigger assembly is spring loaded, the two chisels 122, 123 return to the starting point once the actuating force from a user pulling out a utensil 160 is released. This has the effect of moving the lower chisel 123 out toward the handle end of a utensil 160 into the shelf position, and returning the upper chisel 122 back to its original (or retracted state) position. When this happens, the handle end of the on-deck utensil 162 drops onto the lower chisel 123 (see FIG. 16), lower chisel 123 once again serving as a shelf. The trigger assembly is now back at the starting point with a new ready utensil 161 (previously the on-deck utensil 162) and a new on-deck utensil 162 in position.

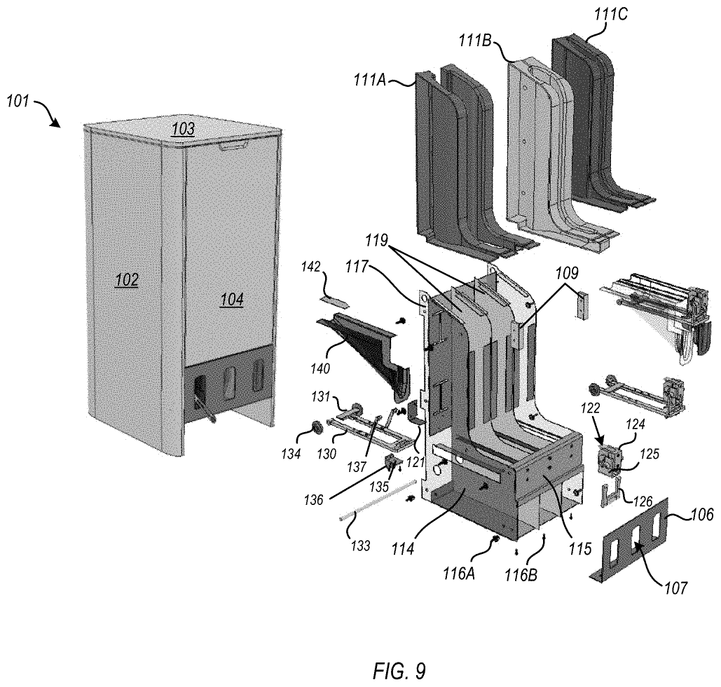

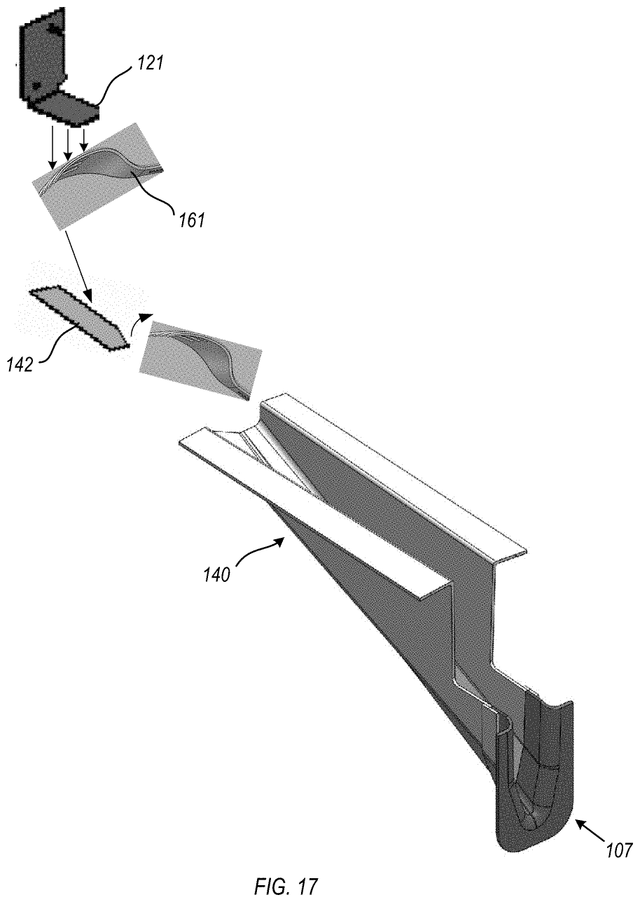

When a utensil 160/161/162 . . . 16N (represented hereafter for simplicity as simply “utensil 160”) drops into the chute 140, it slides down a diagonal slide (see FIGS. 9 and 17) and is stopped such that only the handle of the utensil 160 protrudes from the opening 107 in the facing panel 106 at the cutlery distribution area 105 of system 100.

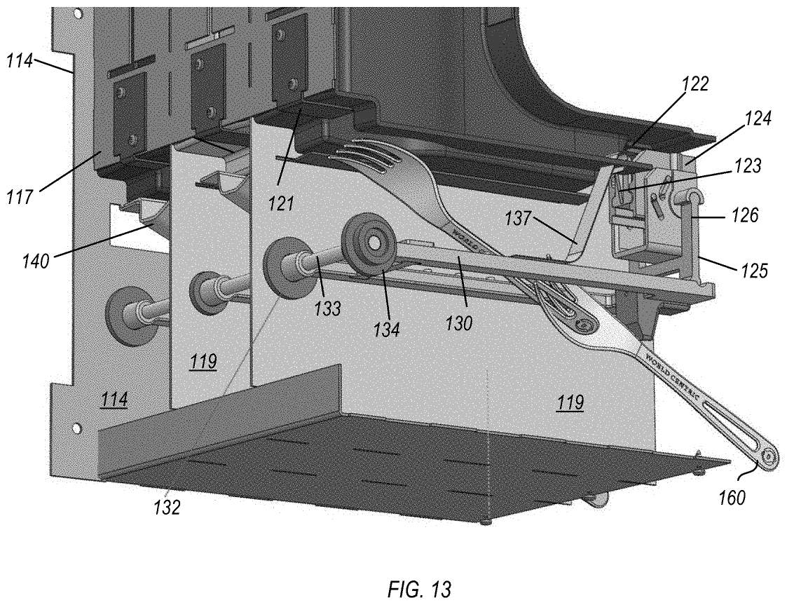

The functional eating end of the utensil 160 is retained within housing 101 by a movable barrier element 136. Referring now to FIGS. 13 to 15, when a user pulls the exposed handle end of the utensil 160 towards them, the barrier element 136, which is spring loaded, moves upward until the widest geometry at the eating end of the utensil 160 has passed by. Thereafter, under spring bias the barrier element 136 returns to its starting (retracted state) position.

The barrier element 136 moving upwards is the activation mechanism by which the trigger assembly operates as previously described. Namely, a button 135 is connected to (or integral with) the bottom of the barrier element 136. When a load of utensils 160 is initially placed into a given stack chamber 111A-C of the stack assembly 110, the operator needs to push the barrier element 136 upward in order to drop the first lowest seated utensil 160 at the bottom of the refill cartridge 150 into the chute 140.

Referring now to FIG. 17, an explanation of how a utensil is rotated is described. The chute 140, with an ejection tab 142 interposed between the fixed shelf 121 and a rear upper end of chute 140, is arranged such that when a ready utensil 161 drops eating end first off fixed shelf 121 toward the chute 140 to become the next presenting utensil 160 handle end out to a next user, the eating end (here the fork times) hits ejection tab 142, which starts the reorientation and rotation of ready utensil 161 as it rotates a full 90 degrees from entry to exit out of the chute 140. Each of the three chutes 140 are unique for this function.

The top access panel 103 is hinged such that it can remain open in any position. When it is in the down position, closed, it holds the top edge of the front access panel 104 in place. The top edge of the front access panel 104 may be held in place by another mechanism as well, such as a magnet or latch. The bottom edge of the front access panel 104 is keyed into a trough or slot (not shown) such that it will not come forward when placed in the slot that is located between the front lower plate 115 and the facing panel 106. The bottom of the front access panel 104 is notched to fit into this slot. So, to reinstall the front access panel 104 (such as after a loading operation), an operator places the bottom edge into this slot, pivots the panel 104 rearward to a vertical position, then secures its top edge by bringing down top access panel 103 to the closed position which holds the top of the front access panel 104 in place.

The example embodiments having been described, it is apparent that such have many varied applications. For example, the example embodiments may be applicable but not limited to connection to various devices, structures and articles. The present invention, in its various embodiments, configurations, and aspects, includes components, systems and/or apparatuses substantially as depicted and described herein, including various embodiments, sub-combinations, and subsets thereof. Those of skill in the art will understand how to make and use the present invention after understanding the present disclosure. The present invention, in its various embodiments, configurations, and aspects, includes providing devices in the absence of items not depicted and/or described herein or in various embodiments, configurations, or aspects hereof, including in the absence of such items as may have been used in previous devices, e.g., for improving performance, achieving ease and\or reducing cost of implementation.

Moreover, though the description of the invention has included description of one or more embodiments, configurations, or aspects and certain variations and modifications, other variations, combinations, and modifications are within the scope of the invention, e.g., as may be within the skill and knowledge of those in the art, after understanding the present disclosure. It is intended to obtain rights which include alternative embodiments, configurations, or aspects to the extent permitted, including alternate, interchangeable and/or equivalent structures to those claimed, whether or not such alternate, interchangeable and/or equivalent structures disclosed herein, and without intending to publicly dedicate any patentable subject matter.

1. A dispensing system for utensils and cutlery, comprising:
a housing having a cutlery distribution area with at least one opening therein for exposing a handle end of a presenting utensil for removal by a user,
a stack assembly provided in the housing, the stack assembly having at least one stack chamber configured to hold a vertical stack of utensils and aligned with the at least one opening,
a trigger assembly actuated by the user removing a single presenting utensil out of the at least one opening to release a single lowest utensil from the vertical stack, for presentation of its handle end extending out of the at least one opening at the cutlery presentation area for removal by a next user of the system, and
a chute for delivering each released single lowest utensil of a vertical stack to its at least one opening for removal by the next user, wherein the chute causes a released single lowest utensil to rotate 90 degrees about its axis from entry into the chute to exit at the opening.

2. The system of claim 1, wherein the user does not have to physically touch any part of the housing of the system, other than the specific presenting handle end of the utensil they wish to remove for use.

3. The system of claim 1, wherein the stack assembly further includes multiple stack chambers in adjacent relation to one another, each to include any of a fork stack chamber, spoon stack chamber, spork stack chamber, knife stack chamber, or any combination thereof.

4. The system of claim 1, wherein the top of the at least one stack chamber and an interior passage extending downward within has a unique shape that mimics the profile of one of a group of utensils comprising a fork, spoon, spork, knife, or other utensil.

5. The system of claim 1, wherein
the at least one stack chamber further includes a central, vertically oriented recessed channel formed directly into the front surface of the stack chamber so that it presents a vertical opening for access into the channel at the stack chamber front, the recessed channel extending from the top of the stack chamber down substantially its entire vertical length for operator access through the front surface into the vertical opening to clear jams at any level within the at least one stack chamber,
the recessed channel adapted to accommodate a vertical stack of utensils inserted face down therein such that the handle end is exposed out of the channel and the face down eating end extends inward within the recessed channel of the at least one stack chamber.

6. The system of claim 1, wherein the housing is composed of a wood product.

7. (canceled)

8. The system of claim 1, wherein the trigger assembly further includes:
a fixed shelf within the housing, the fixed shelf adapted to face and engage an eating end of a given single lowest utensil of the vertical stack within the at least one stack chamber,
a movable shelf opposite the fixed shelf in spaced relation thereto and adapted to face and engage a handle end of the given single lowest utensil of the vertical stack.

9. The system of claim 8, wherein the movable shelf further includes:
an upper chisel and a lower chisel, each of which are arranged so as to come into contact with the handle end of a utensil, and
each being further adapted to move counter-cyclically via defined paths via a corresponding axle attached thereto which shifts in its corresponding defined path, depending on whether a handle end of a presenting utensil is being removed by a user from the at least one opening at the cutlery presentation area.

10. The system of claim 9, wherein, with a presenting utensil exposed through the at least one opening,
the vertical stack of utensils further includes a new lowest utensil in a ready position and a next-lowest utensil in an on-deck position directly above the new lowest utensil, and
upon actuation via a user pulling out the presenting utensil by its exposed handle end from the at least one opening, the upper chisel moves laterally inward toward a handle end to act as a shelf for the next-lowest utensil in the on-deck position, and then the lower chisel retracts laterally away from a handle end to allow the new lowest utensil in the ready position to drop into the chute, so as to become the next presenting utensil with its handle end exposed through the at least one opening for removal by a next user.

11. The system of claim 10, wherein the handle end of the new lowest utensil in the ready position drops first into the chute, with the fixed shelf supporting the eating end thereof.

12. The system of claim 11, wherein as the new lowest utensil in the ready position drops into the chute to become the presenting utensil for removal by the user at the at least one opening, it rotates 90 degrees from entry into to exit out of the chute.

13. The system of claim 1, wherein the trigger assembly further includes:
a spring, and
an actuator arm pivotable at one end and connected to a movable shelf at its other end, the spring attached at one end to a surface of the actuator arm with the other end engaging an underside surface of the at least one stack chamber so as to be able to slide so as to provide a spring function, wherein
upon actuation via a user pulling out the presenting utensil by its exposed handle end from the at least one opening, a spring force imparted by the spring causes the actuator arm to pivot and the movable shelf to adjust back to a starting position in which a new lowest utensil of the vertical stack in a ready position is dropped into the chute, so as to become the next presenting utensil with its handle end exposed through the at least one opening for removal by a next user, and a next-lowest utensil in the vertical stack is placed in the ready position.

14. A utensil dispensing system, comprising:
a housing, a lower part of which includes a plurality of spaced adjacent openings therein, each opening exposing a handle end of a presenting utensil for removal by a user,
a plurality of stack chambers in adjacent relation to one another, each configured to hold a vertical stack of utensils and aligned with a corresponding opening,
a trigger assembly actuated by the user removing a single presenting utensil out of one of the openings by its handle end to release a single lowest utensil from the vertical stack within the stack chamber associated with that opening, as a next presenting utensil for removal by a next user of the system, and
a chute for delivering each released single lowest utensil to its corresponding opening for removal by the next user, the released single lowest utensil subject to rotation about its axis as it is released into the chute.

15. The system of claim 14, wherein the chute causes the released single lowest utensil to rotate 90 degrees from entry into the chute to its exit into its corresponding the opening.

16. The system of claim 14, wherein the trigger assembly further includes:
a fixed shelf adapted to face and engage an eating end of a given single lowest utensil of the vertical stack within a given stack chamber,
an upper chisel and a lower chisel in spaced relation to the fixed shelf, each of the upper and lower chisel arranged so as to come into contact with the handle end of the given single lowest utensil, and
each of the upper and lower chisel being further adapted to move counter-cyclically via defined paths via a corresponding axle attached thereto which shifts in its corresponding defined path, depending on whether the handle end of the presenting utensil at the opening is being removed by the user.

17. The system of claim 14, wherein, with a presenting utensil exposed through the opening,
each vertical stack further includes a new lowest utensil in a ready position and a next-lowest utensil in an on-deck position directly above the new lowest utensil, and
upon actuation via a user pulling the presenting utensil by its exposed handle end from the opening, an upper chisel in the trigger assembly moves laterally inward toward a handle end to act as a shelf for the next-lowest utensil in the on-deck position, and then a lower chisel of the trigger assembly retracts laterally away from a handle end to allow the new lowest utensil in the ready position to drop into the chute, so as to become the next presenting utensil with its handle end exposed through the opening for removal by a next user.

18. The system of claim 17, wherein the handle end of the new lowest utensil in the ready position drops first into the chute, with the fixed shelf supporting the eating end thereof.

19. A utensil dispensing system, comprising:
a housing, a lower part of which includes a plurality of spaced adjacent openings therein, each opening exposing a handle end of a presenting utensil for removal by a user,
a plurality of stack chambers in adjacent relation to one another, each configured to hold a vertical stack of utensils and aligned with a corresponding opening, each stack chamber having a central, vertically oriented recessed channel formed directly into the front surface of the stack chamber so that it presents a vertical opening for access into the channel at the stack chamber front, the recessed channel extending from the top of the stack chamber down substantially its entire vertical length for operator access through the front surface into the vertical opening to clear jams at any level within the at least one stack chamber, and
a trigger assembly actuated by the user removing a single presenting utensil out of one of the openings by its handle end to release a single lowest utensil from the vertical stack within the stack chamber associated with that opening, as a next presenting utensil for removal by a next user of the system.

20. The system of claim 19, wherein an interior footprint of the recessed channel is of a shape that respectively mimics the profile of one or more of a fork, spoon, spork, and knife.
